(19) United States
(12) Patent Application Publication
(10) Pub. No.: US 2007/0164941 A1
(43) Pub. Date: Jul. 19, 2007

(54) Display device with enhanced brightness and driving method thereof

(76) Inventors: Kyong-Tae Park, Uijeongbu-si (KR); Dae-Jin Park, Incheon-si (KR); Jung-Nam Park, Hamyang-gun (KR)

Correspondence Address: MACPHERSON KWOK CHEN & HEID LLP, 2033 GATEWAY PLACE, SUITE 400, SAN JOSE, CA, 95110, US

(21) Appl. No.: 11/653,512

(22) Filed: Jan. 12, 2007

(30) Foreign Application Priority Data
Jan. 16, 2006 (KR) 10-2006-0004295

(51) Int. Cl. G09G 3/30

(52) U.S. Cl. 345/77

(57) ABSTRACT

A display device that does not suffer from blurring or reduction in brightness is presented. The device includes a plurality of pixels, a scan driver, a signal controller, and a data driver. Each pixel includes a light-emitting element and a driving transistor that outputs a driving current to the light-emitting element. The scan driver supplies a scan signal to the pixels. The signal controller generates a first output image signal representing a brightness higher than a reference brightness and a second output image signal representing a brightness lower than the reference brightness. The data driver converts the first output image signal and the second output image signal into a first and second data voltages and alternately supplies the two data voltages to the pixels. This way, the same images are displayed with a first period and a second period having a different brightness levels, achieving an impulsive effect between frames.

### CROSS-REFERENCE TO RELATED APPLICATION

This application claims priority to and the benefit of Korean Patent Application No. 10-2006-0004295 filed in the Korean Intellectual Property Office on Jan. 16, 2006, the contents of which are incorporated herein by reference.

### BACKGROUND OF THE INVENTION

(a) Field of the Invention

The present invention relates to a display device and a driving method thereof.

(b) Description of the Related Art

Recently, flat panel displays have been researched heavily as a potential successor to cathode ray tube (CRT) as the next generation mainstream display. Particularly, an organic light-emitting diode (OLED) display, which has excellent luminescence and viewing angle characteristics, has been receiving much attention as a next-generation flat panel display.

In general, in an active type flat panel display, a plurality of pixels are arranged in a matrix configuration. An image is displayed by controlling the light strength of each pixel according to given brightness information. The OLED display is a display device that displays an image by electrically exciting a fluorescent organic material to emit light. The OLED display is a self-light-emitting type and has low power consumption and a rapid response speed of pixels. Furthermore, it can easily display a motion picture of high image quality.

The OLED display includes an OLED and a thin film transistor (TFT) for driving the OLED. The TFT may be classified into a polysilicon TFT, an amorphous silicon TFT, and the like, depending on the type of material used in the active layer. An OLED display adopting a polysilicon TFT has several merits and has thus been widely used, but the manufacturing process of the polysilicon TFT is complicated, resulting in high cost. Furthermore, it is difficult to make a large screen OLED display with a polysilicon TFT. In contrast, an OLED display adopting an amorphous silicon TFT can be easily made into a large screen and has fewer steps in the manufacturing process compared to that of the OLED display adopting the polysilicon TFT. However, the OLED display with an amorphous silicon TFT is problematic in that a blurring phenomenon, in which the edges of an object in the image are blurred when displaying a motion picture, occurs. This blurring phenemonon occurs because the OLED with an amorphous silicon TFT is a hold type display device.

To prevent the blurring phenomenon, an OLED display that impulsively drives has been proposed. In the OLED display, the blurring phenomenon can be prevented by inserting a black image between the image of one frame and the image of a next frame.

In the OLED display, however, the black image is displayed during a predetermined time of one frame. Accordingly, the brightness of the whole screen becomes reduced by up to 50%.

### SUMMARY OF THE INVENTION

According to an embodiment of the present invention an OLED display having an impulsive effect without a reduction in brightness is provided.

In one aspect, the invention is a display device that includes a plurality of pixels, a scan driver, a signal controller, and a data driver. Each of the plurality of pixels includes a light-emitting element and a driving transistor that outputs a driving current to the light-emitting element. The scan driver supplies a scan signal to the pixels. The signal controller generates a first output image signal representing a brightness higher than a reference brightness and a second output image signal representing a brightness lower than the reference brightness, wherein an input image signal represents the reference brightness. The data driver converts the first output image signal and the second output image signal into a first data voltage and a second data voltage, respectively, and alternately supplies the first data voltage and the second data voltage to the pixels. The first output image signal and the second output image signal are different from each other with respect to the input image signal.

The first and second output image signals may be functions of the input image signal.

The first and second output image signals may be a linear functions of the input image signal.

For example, y1=x and y2=ax (0<a<1), where y1 denotes the first output image signal divided by a total grayscale number, y2 denotes the second output image signal divided by the total grayscale number, and x denotes the input image signal divided by the total grayscale number. A grayscale number of the second output image signal may be smaller than that of the first output image signal. The first data voltage may be higher or lower than a data voltage of the reference brightness.

In another example, y1=xb (0.4<b<1) and y2=xc (1.0<c<2.5), where y1 denotes the first output image signal divided by a total grayscale number, y2 denotes the second output image signal divided by the total grayscale number, and y3 denotes the input image signal divided by the total grayscale number.

In yet another example, y1=xd (0.4<d<1) and y2=fxe (1.0<e<2.5, 0.7<f<1), where y1 denotes the first output image signal divided by a total grayscale number, y2 denotes the second output image signal divided by the total grayscale number, and x denotes the input image signal divided by the total grayscale number.

A conversion equation for converting the input image signal into the first and second output image signals may be different depending on a color representing the input image signal.

An average of the brightness represented by the first output image signal and the brightness represented by the second output image signal may correspond to the reference brightness represented by the input image signal.

The signal controller may include a first data converter that converts the input image signal into the first output image signal according to a first lookup table, a second data converter that converts the input image signal into the second output image signal according to a second lookup table, and a select unit that selects one of the first output image signal and the second output image signal and outputs the selected signal to the data driver.

The display device may further include a voltage generator that applies a gray voltage to the data driver. The data driver may select the first and second data voltages based on the gray voltage.

In another aspect, the invention is a driving method of a display device including a plurality of pixels having a light-emitting element and a driving transistor that outputs a driving current to the light-emitting element. The method includes converting an input image signal representing a reference brightness into a first output image signal representing a first brightness higher than the reference brightness, converting the first output image signal into a first data voltage, supplying the first data voltage to the pixels, converting the input image signal into a second output image signal representing a second brightness lower than the reference brightness, converting the second output image signal into a second data voltage, and supplying the pixels with the second data voltage.

The first and second output image signals may be functions of the input image signal.

### BRIEF DESCRIPTION OF THE DRAWINGS

FIG. 1 is a block diagram of an OLED display according to an exemplary embodiment of the present invention.

FIG. 2 is an equivalent circuit diagram of one pixel of the OLED display according to an exemplary embodiment of the present invention.

FIG. 3 is a cross-sectional view showing a driving transistor and an organic light-emitting element of one pixel of the OLED display shown in FIG. 2.

FIG. 4 is a schematic diagram of the organic light-emitting element of the OLED display according to an exemplary embodiment of the present invention.

FIG. 5 is a block diagram of a signal controller according to an exemplary embodiment of the present invention.

FIGS. 6, 7, and 8 are graphs illustrating the relationship between an input image signal and an output image signal.

FIG. 9 shows a signal waveform illustrating the operation of the OLED display according to an exemplary embodiment of the present invention.

FIG. 10 is a schematic diagram illustrating one example of the screen of the OLED display, which is displayed according to FIG. 9.

FIG. 11 is a graph showing an output grayscale and a mean value, which are converted using the conversion equation used for FIG. 7, as a function of an input grayscale.

### DETAILED DESCRIPTION OF THE EMBODIMENTS

With reference to the accompanying drawings, the present invention will be described in order for those skilled in the art to be able to implement the invention.

To clarify multiple layers and regions, the thicknesses of the layers are enlarged in the drawings. Like reference numerals designate like elements throughout the specification. When it is said that any part, such as a layer, film, area, or plate, is positioned on (e.g., mounted on) another part, it means the part is directly on the other part or above the other part with at least one intervening part. On the other hand, if any part is said to be positioned “directly” on another part it means that there is no intervening part between the two parts.

Hereinafter, a display device according to an exemplary embodiment of the present invention will be described in detail with reference to the accompanying drawings.

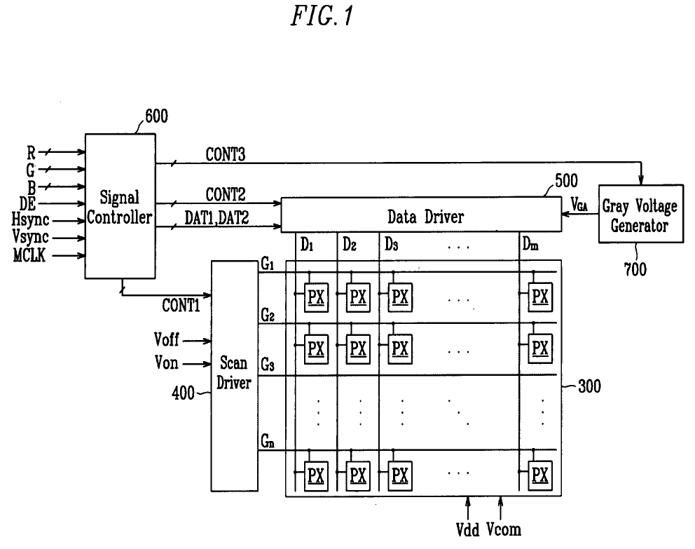

FIG. 1 is a block diagram of an OLED display according to an exemplary embodiment of the present invention.

Referring to FIG. 1, the OLED display according to an exemplary embodiment of the present invention includes a display panel 300, a scan driver 400 connected to the display panel 300, a data driver 500, and a gray voltage generator 700. A signal controller 600 controls the above-mentioned elements.

When viewed in an equivalent circuit, the display panel 300 includes a plurality of signal lines G₁-Gₙ, D₁-Dₘ, a plurality of voltage lines (not shown), and a plurality of pixels PX which are connected to the signal lines and the voltage lines. The pixels are arranged in approximately a matrix configuration.

The signal lines G₁-Gₙ, D₁-Dₘ include a plurality of scanning signal lines G₁-Gₙ that transfer a scan signal, and data lines D₁-Dₘ that transfer a data signal. The scanning signal lines G₁-Gₙ extend in a first direction, and are substantially parallel to each other and separated from each other. The data lines D₁-Dₘ extend approximately in a second direction that is perpendicular to the first direction and are substantially parallel to each other. Each voltage line (not shown) transfers a driving voltage Vdd and so on.

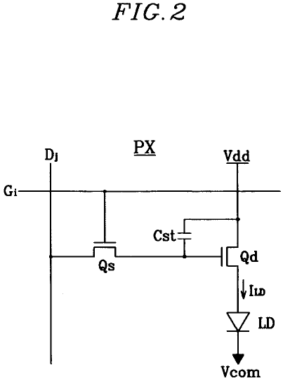

FIG. 2 is an equivalent circuit diagram of one pixel of the OLED display according to an exemplary embodiment of the present invention.

Referring to FIG. 2, one pixel of the OLED display according to an exemplary embodiment of the present invention (for example, a pixel connected to an i-th scanning signal line Gᵢ and a j-th data line Dⱼ) includes an OLED LD, a driving transistor Qd, a capacitor Cst, and a switching transistor Qs.

The switching transistor Qs has a control terminal, an input terminal, and an output terminal. The control terminal is connected to the scanning signal line Gᵢ, the input terminal is connected to the data line Dⱼ, and the output terminal is connected to a control terminal of the driving transistor Qd. The switching transistor Qs transfers a data voltage in response to a scan signal received through the scanning signal line Gᵢ.

The driving transistor Qd has a control terminal, an input terminal, and an output terminal. The control terminal is connected to the switching transistor Qs, the input terminal is connected to the driving voltage Vdd, and the output terminal is connected to the OLED LD. The driving transistor Qd flows a driving current I_{LD} the amount of which varies depending on a voltage applied to the control terminal and the output terminal of the driving transistor Qd.

The capacitor Cst is connected between the control terminal and the input terminal of the driving transistor Qd. The capacitor Cst charges the data signal applied to the control terminal of the driving transistor Qd and maintains the data signal even after the switching transistor Qs is turned off.

The OLED LD has an anode connected to the output terminal of the driving transistor Qd and a cathode connected to a common voltage Vcom. The OLED LD displays an image by emitting light of an intensity level that changes depending on the output current I_{LD} of the driving transistor Qd.

The switching transistor Qs and the driving transistor Qd may be an N channel field effect transistor (FET) made of amorphous silicon or polysilicon. However, at least one of the switching transistor Qs and the driving transistor Qd may be a P channel field effect transistor. Furthermore, the connection relationship of the transistors Qs, Qd, the capacitor Cst, and the OLED LD may be changed from the exemplary embodiment.

The structure of the driving transistor Qd and the OLED LD of the OLED display will be described below.

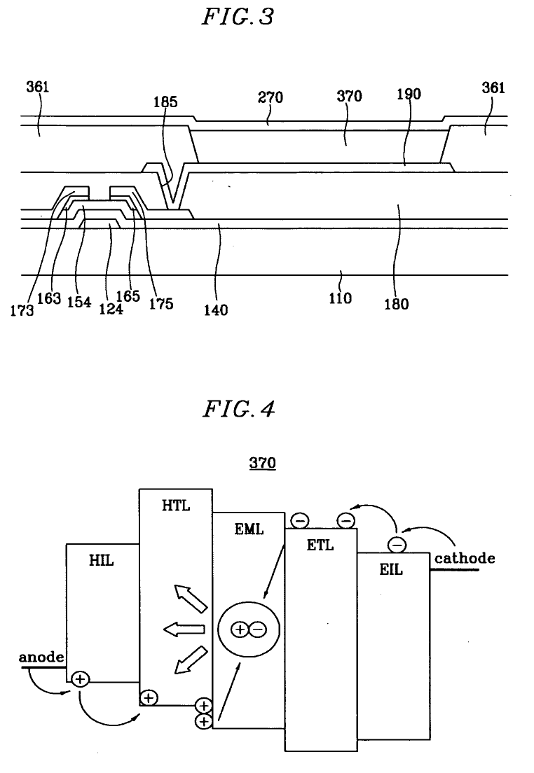

FIG. 3 is a cross-sectional view of the driving transistor Qd and the OLED LD of one pixel of the OLED display according to an exemplary embodiment of the present invention.

In the OLED display, a control electrode 124 is formed on an insulation substrate 110. The control electrode 124 may be formed using an aluminum-based metal such as aluminum (Al) and aluminum alloy, a silver-based metal such as silver (Ag) and silver alloy, a copper-based metal such as copper (Cu) and copper alloy, a molybdenum-based metal such as molybdenum (Mo) and molybdenum alloy, chromium (Cr), tantalum (Ta), titanium (Ti), or the like. However, the control electrode 124 may have a multi-film structure including two conductive layers (not shown) with different physical properties. One of the conductive layers may be formed using metal with a low resistivity, such as an aluminum-based metal or a copper-based metal, in order to reduce signal delay or voltage drop. Unlike the above, the conductive layers may be formed using materials having good physical, chemical, and electrical contact characteristics with other materials (more particularly, with ITO (indium tin oxide) and IZO (indium zinc oxide)), such as a molybdenum-based metal, chromium, tantalum, titanium, or the like. Preferred combinations include a lower chromium film and an upper aluminum (alloy) film, or a lower aluminum (alloy) film and an upper molybdenum (alloy) film. However, the control electrode 124 may be formed using several metals or conductors other than the above-mentioned metals. The lateral sides of the control electrode 124 slope in the range of about 30° to 80° to the surface of the substrate 110.

An insulating layer 140 made of silicon nitride (SiNx) is formed on the control electrode 124.

A semiconductor 154 made of hydrogenated amorphous silicon (amorphous silicon is commonly abbreviated to “a-Si”), polycrystalline silicon, or the like is formed on the insulation layer 140. A pair of ohmic contacts 163 and 165 may be formed using a material, such as silicide or n+ hydrogenated amorphous silicon, into which an n-type impurity of a high concentration is doped, and are formed on the semiconductor 154. The lateral sides of the semiconductor 154 and the ohmic contacts 163 and 165 also slope to form an angle of about 30° to 80° with respect to the surface of the substrate 110.

An input electrode 173 and an output electrode 175 are formed on the ohmic contacts 163 and 165, and the insulation layer 140. The input electrode 173 and the output electrode 175 may be formed using chromium or a molybdenum-based metal, a refractory metal such as tantalum or titanium, or the like. The input electrode 173 and the output electrode 175 may have a multi-film structure including a lower film made of a refractory metal (not shown) and an upper film made of a low resistance material (not shown). Examples of the multi-film structure may include a dual film of a lower chromium or molybdenum (alloy) film and an upper aluminum film, a triple film of a lower molybdenum (alloy) film, an intermediate aluminum (alloy) film, and an upper molybdenum (alloy) film, and so on. The lateral sides of the input electrode 173 and the output electrode 175 also slope to form an angle of about 30° to 80° with respect to the surface of the substrate 110 in the same manner as the input electrode 124, etc.

The input electrode 173 and the output electrode 175 are separated from each other and are located at both sides of the control electrode 124. The control electrode 124, the input electrode 173, and the output electrode 175 form the driving transistor Qd along with the semiconductor 154. A channel is formed on the semiconductor 154 between the input electrode 173 and the output electrode 175.

The ohmic contacts 163 and 165 exist only between the underlying semiconductor 154 and the overlaying input electrode 173 and output electrode 175, and function to reduce the contact resistance therebetween. The semiconductor 154 includes a portion that is not covered with the input electrode 173 or the output electrode 175.

A passivation layer 180 is formed on the input electrode 173 and the output electrode 175, the portion of the semiconductor 154 that is not covered by the input electrode 173 or the output electrode 175, and the insulation layer 140. The passivation layer 180 may contain an inorganic insulator, such as silicon nitride (SiNx) or silicon oxide (SiOx), an organic insulator, an insulation material with a low dielectric constant, or the like. The insulation material with a “low dielectric constant” may have a dielectric constant of 4.0 or less. A preferred example of the insulation material may include a-Si:C:O, a-Si:O:F, or the like, and may be formed by plasma enhanced chemical vapor deposition (PECVD). The passivation layer 180 may be formed using an organic insulating material with photosensitivity. The passivation layer 180 may have a flat surface. In some embodiments, the passivation layer 180 may have a dual layer structure of a lower inorganic layer and an upper organic layer so that it can have the merits of the organic layer while protecting the exposed portion of the semiconductor 154. A contact hole 185 through which the output electrode 175 is exposed is formed in the passivation layer 180.

A pixel electrode 190 is formed on the passivation layer 180. The pixel electrode 190 is connected to the output electrode 175 physically and electrically through the contact hole 185, and may be formed using a transparent conductive material, such as ITO or IZO, or a metal with good reflectivity, such as aluminum or silver alloy.

Barrier ribs 361 are also formed on the passivation layer 180. The barrier ribs 361 surround the edges of the pixel electrode 190 like banks, thus defining an opening, and may contain an organic insulation material, an inorganic insulation material, or the like.

An organic light-emitting member 370 is formed on the pixel electrode 190. The organic light-emitting member 370 is confined in the opening that is formed by the barrier ribs 361.

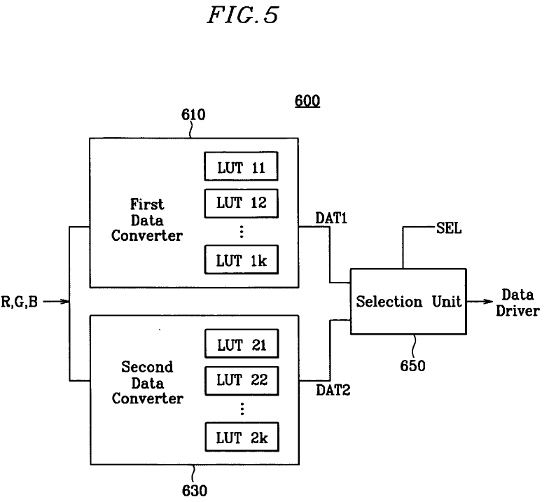

FIG. 4 is a schematic diagram of the OLED LD according to an exemplary embodiment of the present invention.

The organic light-emitting member 370 has a multi-layer structure including layers, in addition to an emitting layer EML, for improving the luminous efficiency of the emitting layer EML, as shown in FIG. 4. The additional layers may include an electron transport layer ETL and a hole transport layer HTL for balancing electrons and holes, and an electron injection layer EIL and a hole injection layer HIL for enhancing the injection of electrons and holes. These additional layers may be omitted, depending on the embodiment.

A common electrode 270 to which the common voltage Vcom is applied is formed on the barrier ribs 361 and the organic light-emitting member 370. The common electrode 270 may be made of a reflective metal containing calcium (Ca), barium (Ba), aluminum (Al), and so on, or a transparent conductive material such as ITO or IZO.

An opaque pixel electrode 190 and a transparent common electrode 270 may be applied to an OLED display of a front light-emitting (top emission) method of displaying an image upwardly from the display panel 300. A transparent pixel electrode 190 and an opaque common electrode 270 may be applied to an OLED display of a rear light-emitting (bottom emission) method of displaying an image downwardly from the display panel 300.

The pixel electrode 190, the organic light-emitting member 370, and the common electrode 270 form the OLED LD shown in FIG. 2. The pixel electrode 190 becomes an anode and the common electrode 270 becomes a cathode, or the pixel electrode 190 becomes a cathode and the common electrode 270 becomes an anode. The OLED LD emits light of one of the primary colors, i.e., red, green, and blue, according to the material of the organic light-emitting member 370. A desired color can be displayed through a spatial combination of the three primary colors.

Referring back to FIG. 1, the scan driver 400 is connected to the scanning signal lines G₁-Gₙ of the display panel 300 and applies scan signals Vg₁-Vgₙ, which are formed by a combination of a high voltage Von that can turn on the switching transistor Qs and a low voltage Voff that can turn off the switching transistor Qs, to the scanning signal lines G₁-Gₙ, respectively.

The data driver 500 is connected to the data lines D1-Dm of the display panel 300 and applies a data voltage representing an image signal to the data lines D1-Dm.

The gray voltage generator 700 generates a gray voltage VGA according to a grayscale control signal CONT3 from the signal controller 600 and outputs the generated gray voltage to the data driver 500.

The scan driver 400, the data driver 500, and the gray voltage generator 700 may be directly mounted on the display panel 300 in the form of a plurality of driving IC chips or may be mounted on a flexible printed circuit film (not shown), and may then be attached to the display panel 300 in the form of a tape carrier package (TCP). Alternatively, the scan driver 400, the data driver 500, or the gray voltage generator 700 may be formed on the display panel 300 along with the signal lines and the transistors, thereby forming a system-on-panel (SOP).

The signal controller 600 controls the operation of the scan driver 400, the data driver 500, the gray voltage generator 700, and so on.

The structure of the signal controller 600 will be described in detail in reference to FIG. 5.

FIG. 5 is a block diagram of the signal controller according to an exemplary embodiment of the present invention.

Referring to FIG. 5, the signal controller 600 according to an exemplary embodiment of the present invention includes a first data converter 610, a second data converter 630, and a selection unit 650.

The first data converter 610 includes a plurality of first lookup tables LUT11, LUT12, . . . , LUT1k and converts input image signals R, G, and B into a first output image signal DAT1.

The second data converter 630 includes a plurality of second lookup tables LUT21, LUT22, . . . , LUT2k and converts the input image signals R, G, and B into a second output image signal DAT2.

The lookup tables LUT11, LUT12, . . . , LUT1k, LUT21, LUT22, . . . , LUT2k may be grouped depending on the type of the input image signals R, G, and B, such as colors represented by the input image signals R, G, and B.

The selection unit 650 receives the first output image signal DAT1 and the second output image signal DAT2 from the first data converter 610 and the second data converter 630, respectively, and selectively outputs the signals to the data driver 500.

The first and second data converters 610 and 630 and the selection unit 650 may be implemented using devices different from that of the signal controller 600.

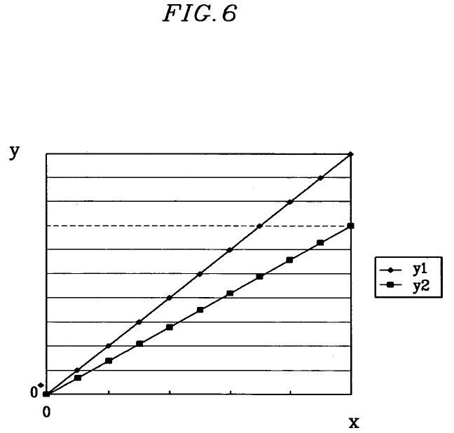

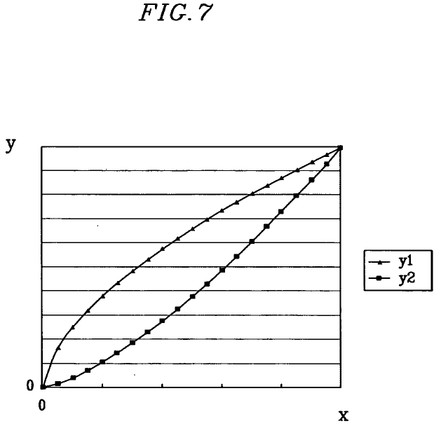

The operation of the OLED display will be described below in detail with reference to FIGS. 6 to 11.

The signal controller 600 receives an input control signal to control the input image signals R, G, and B and the display thereof from an external graphic controller (not shown). The input image signals R, G, and B contain brightness information of each pixel PX. B rightness is indicated by one of a given number of grayscales such as 1024 (=2¹⁰), 256 (=2⁸) or 64 (=2⁶). For example, the input control signal may include a vertical synchronization signal Vsync, a horizontal synchronization signal Hsync, a main clock MCLK, a data enable signal DE, and the like.

The signal controller 600 processes the input image signals R, G, and B so that they are suitable for an operating condition of the display panel 300 based on the input image signals R, G, and B and the input control signal, and generates the scan control signal CONT1, the data control signal CONT2, the grayscale control signal CONT3, and so on. The signal controller 600 sends the scan control signal CONT1 to the scan driver 400, the grayscale control signal CONT3 to the gray voltage generator 700, and the data control signal CONT2 and the output image signals DAT1 and DAT2 to the data driver 500.

The scan control signal CONT1 includes a scanning start signal STV instructing the scanning start of the high voltage Von and at least one clock signal controlling the output cycle of the high voltage Von. The scan control signal CONT1 may also include an output enable signal OE defining the duration time of the high voltage Von.

The data control signal CONT2 includes a horizontal synchronization start signal STH informing the transmission of the digital image signals DAT1 and DAT2 to pixels PX of one row, a load signal LOAD that instructs an analog data voltage to be applied to the data lines D1-Dm, and a data clock signal HCLK.

An in-depth process of converting the input image signals R, G, and B into the output image signals DAT1 and DAT2 will now be described in detail with reference to FIGS. 6 to 8.

FIGS. 6, 7, and 8 are graphs illustrating the relationship between the input image signals and the first and second output image signals.

Referring to FIGS. 6 to 8, the first and second output image signals are functions (e.g., power functions) of the input image signals. The value of the first output image signal (or the first output grayscale) is higher than that of the second output image signal (or the second output grayscale). In the remaining grayscales other than the lowest grayscale or the highest grayscale, the first output grayscale is greater than the second output grayscale. Furthermore, in most cases, the brightness represented by the first output image signal is higher than the reference brightness represented by the input image signal. In contrast, the brightness represented by the second output image signal is lower than the reference brightness represented by the input image signal. However, if the brightness represented by the first output image signal and the brightness represented by the second output image signal are averaged, the resulting brightness becomes almost the same as that represented by the input image signal.

Hereinafter, y1 denotes the first output image signal DAT1 divided by a total grayscale number, y2 denotes the second output image signal divided by the total grayscale number, and x denotes the input image signal divided by the total grayscale number.

Then the following equations 1 and 2 are satisfied.

y1=xP (Equation 1)

y2=r×q (Equation 2)

Here “p” and “r” are positive real numbers smaller than 1 and “q” is a real number greater than 1, and “p”, “r”, and “q” may be varied depending on the environmental factors around the display panel 300, the device condition, and so on.

Such conversion may be a linear conversion. In one embodiment, p=q=1 and 0<r<1. In the example shown in FIG. 6, r=0.7.

In accordance with another exemplary embodiment of the present invention, 0.4<p<1, 1.0<q<2.5, and r=1. In the example shown in FIG. 7, p=0.6, q=1.4.

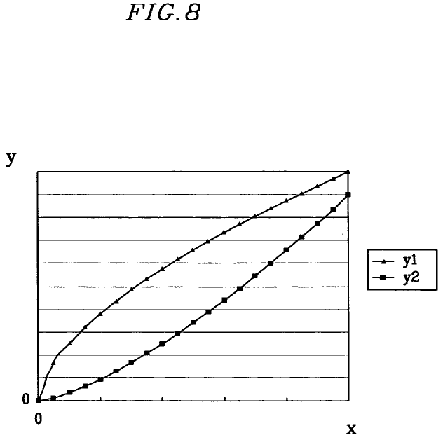

In accordance with another exemplary embodiment of the present invention, 0.4<p<1, 1.0<q<2.5, and 0.7<r<1. In the example shown in FIG. 8, p=0.6, q=1.5 and r=0.9.

If “p” is smaller than 0.4, “q” is greater than 2.5, or “r” is smaller than “0.7”, the image quality may be degraded.

The first and second lookup tables LUT11, LUT12, . . . , LUT1k, LUT21, LUT22, . . . , LUT2k) of the first data converter 610 and the second data converter 630 may store the first and second output grayscales with respect to the entire input grayscales. To reduce the storage capacity, however, only the first and second output grayscales corresponding to several input grayscales may be stored, and the first and second output grayscales may be calculated using an interpolation method, etc., in the first and second lookup tables LUT11, LUT12, . . . , LUT1k, LUT21, LUT22, . . . , LUT2k) with respect to the remaining input grayscales.

The first and second output grayscales may be calculated directly using Equation 1 and Equation 2 instead of using the lookup tables LUT11, LUT12, . . . , LUT1k, LUT21, LUT22, . . . , LUT2k as described above.

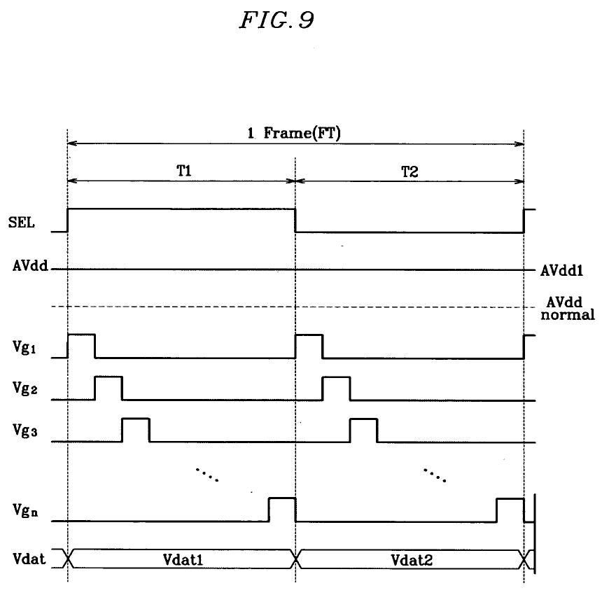

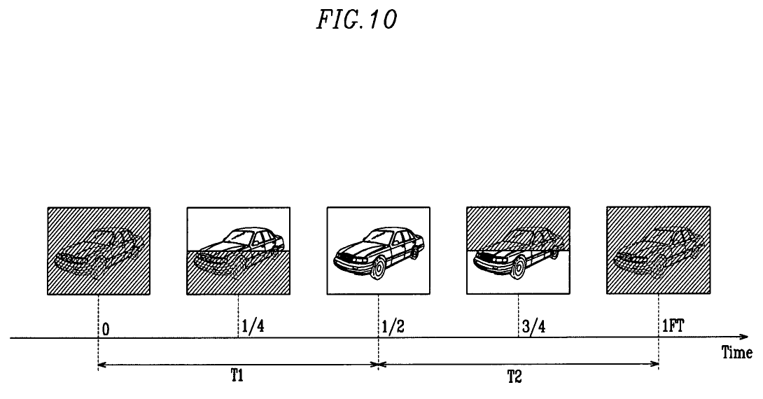

Referring to FIG. 5, the selection unit 650 alternately selects the first output image signal DAT1 and the second output image signal DAT2 that are generated as described above. The output image signals DAT1 and DAT2 may be selected according to the selection signal SEL. A subsequent operation will be described below in detail with reference to FIGS. 9 and 10.

FIG. 9 shows a signal waveform illustrating the operation of the OLED display according to an exemplary embodiment of the present invention. FIG. 10 is a schematic diagram illustrating an example of the screen of the OLED display, which is displayed according to FIG. 9.

When the selection signal SEL input to the selection unit 650 becomes a high level, a first period T1 begins. In the first period T1, the selection unit 650 selects the first output image signal DAT1 of the first data converter 610 and outputs the selected signal DAT1 to the data driver 500.

According to the data control signal CONT2 from the signal controller 600, the data driver 500 receives the first output image signal DAT1 (i.e., a digital signal), selects a gray voltage corresponding to the first output image signal DAT1, converts the first output image signal DAT1 into a first analog data voltage, and applies the first analog data voltages to the corresponding data lines D1-Dm.

The scan driver 400 converts scan signals Vg₁, . . . , Vgₙ, which are applied to the scanning signal lines G₁-Gₙ, into the high voltage Von according to the scan control signal CONT1 of the signal controller 600.

The switching transistor Qs connected to the scanning signal lines G₁-Gₙ is turned on, so that a first data voltage Vdat1 is applied to the driving transistor Qd of the corresponding pixel PX. The driving transistor Qd outputs the driving current I_{LD} corresponding to the first data voltage Vdat1, and the OLED LD emits light corresponding to the driving current I_{LD}.

At this time, since the brightness represented by the first output image signal DAT1 has a value higher than that of the reference brightness represented by the input image signals R, G, and B, the brightness of the light that is emitted has a value higher than that of the reference brightness of a corresponding grayscale.

Such an operation is sequentially performed from a first pixel row to the last pixel row, displaying an image.

When the selection signal SEL shifts to a low level, a second period T2 begins and the selection unit 650 selects the second output image signal DAT2 of the second data converter 630.

The data driver 500 and the scan driver 400 operate in the same manner as in the first period T1, so that a second data voltage Vdat2 corresponding to the second output image signal DAT2 is applied to each pixel PX.

At this time, the brightness of each pixel PX is lower than the reference brightness of the input image signals R, G, and B.

The first period T1 and the second period T2 are repeated and may have the same length. A pair of the first period T1 and the second period T2 form one frame.

From FIG. 10, it can be seen that at the time of an initial frame, an image of a previous frame having a brightness lower than the reference brightness represented by the input image data R, G, and B is displayed on a screen. When the first period T1 begins, the pixels PX on an upper side of the screen begin having a brightness higher than the reference brightness. About quarter of the way into the frame, the pixels PX on the first half of the screen have a brightness higher than the reference brightness. At about ½ frame, the whole screen has a high brightness.

Thereafter, when the second period T2 begins, the pixels PX on the upper side of the screen begin having a brightness lower than the reference brightness. At about ¾ of the way into the frame, the pixels PX on the upper side have a brightness lower than the reference brightness. At the time of the end of the current frame, the whole screen has a low brightness.

The rise and fall of the selection signal SEL may be reversed in the first period T1 and the second period T2.

As described above, if a pixel has a brightness higher than the reference brightness in one of the two periods and the pixel has a brightness lower than the reference brightness in the other of the two periods, with one frame being divided into two periods, an impulsive effect by the brightness difference between the two periods can be obtained and the blurring phenomenon can be reduced accordingly. Furthermore, since a black image is not displayed while obtaining the impulsive effect, a reduction in brightness can be prevented.

If an average of the brightness of the two periods is approximated to the reference brightness, the distortion of an image can be reduced.

Now, reference will be made to the graphs of FIGS. 6 to 8 again.

As shown in FIG. 6, in the case of the linear function, the difference between the first output image signal DAT1 and the second output image signal DAT2 increases as the grayscale of the input image signals R, G, and B becomes high. Human eyes are more sensitive to bright light. Therefore, if the difference between the first output image signal DAT1 and the second output image signal DAT2 becomes great at a high grayscale, the impulsive effect can be increased.

In the case of FIG. 7, the difference between the first output image signal DAT1 and the second output image signal DAT2 is greatest at an intermediate grayscale range, then at a low grayscale. The difference is the smallest at a high grayscale range, unlike in FIG. 6. This is schemed in consideration of the fact that, at many cases of motion images, the image signals representing the high grayscale occupy the smallest portion, and the image signals representing the intermediate grayscale occupy the largest portion.

In the case of FIG. 8, the difference between the first output image signal DAT1 and the second output image signal DAT2 is great at an intermediate grayscale and a low grayscale, and also exists even at a high grayscale, when compared with FIG. 7, so that the impulsive effect can be effectively obtained.

In the case of FIGS. 6 and 8, the highest possible grayscale of the second output image signal DAT2 is lower than the highest possible grayscale of the first output image signal DAT1. Accordingly, the number of grayscales that may be represented by the second output image signal DAT2 is smaller than the number of grayscales that may be represented by the first output image signal DAT1.

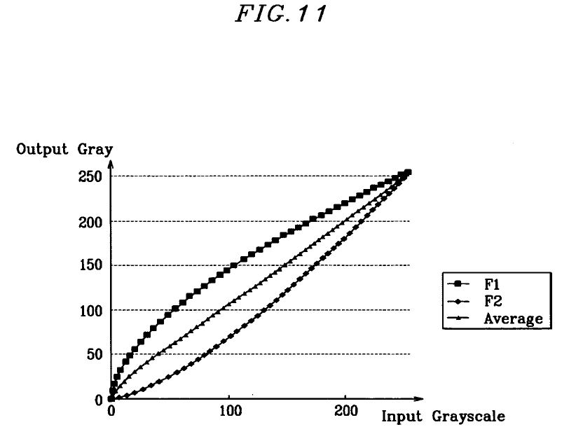

Meanwhile, in the conversions shown in FIGS. 6 to 8, the grayscale must always have an integer value. Accordingly, numbers down to the decimal must be removed from the value obtained through conversion by means of a round-off method, etc. This can be considered as a kind of quantization. If such a quantization process is performed, there may be a difference from the original value. This difference is called a “quantization error”. This will be described in detail with reference to FIG. 11. FIG. 11 is a graph showing first and second output grayscales and their mean values as a function of an input grayscale. The mean values for the first and second output grayscales are converted using the conversion equation used for FIG. 7. Each of an input image signal and first and second output image signals is 8 bits long, a function representing a first output grayscale is F1, and a function representing a second output grayscale is F2.

Referring to FIG. 11, in the function F1, since the slope decreases at a high grayscale range, lots of quantization error occur at the high grayscale range. In contrast, in the function F2, since the decreases at a low grayscale range, lots of quantization error occur at the low grayscale range. However, the brightness by the first output image signal DAT1 and the brightness by the second output image signal DAT2 are combined and visually recognized as the mean value. Accordingly, at the high grayscale range, the high quantization error of the first output image signal DAT1 is compensated for by the second output image signal DAT2. In contrast, at the low grayscale range, the high quantization error of the second output image signal DAT2 is compensated for by the first output image signal DAT1. This way, as can be seen from FIG. 11, the mean value maintains linearity.

In Equation 1 and Equation 2, however, if “p” is smaller than 0.4, “q” is greater than 2.5, or “r” is smaller than 0.7, there is a possibility that quantization error may be increased, resulting in a degraded image quality.

Meanwhile, in the exemplary embodiment shown in FIG. 6, the grayscale of the first output image signal DAT1 is the same as that of the input image signals R, G, and B. Therefore, it is necessary to set high the gray voltage generated by the gray voltage generator 700 in comparison with a normal case in order to make the brightness represented by the first output image signal DAT1 higher than the reference brightness represented by the input image signals R, G, and B. In doing so, the first data voltage Vdat corresponding to predetermined input image signals R, G, and B is higher than the data voltage that represents the reference brightness represented by the input image signals R, G, and B. Of course, the opposite is true when the driving transistor Qd is a p-type.

The above effect can be achieved by controlling the driving voltage Vdd and the common voltage Vcom to be high or low instead of setting the gray voltage high or low in comparison with a normal case.

As described above, according to embodiments of the present invention, one frame is divided into two periods. The two periods are set to have different brightness. Furthermore, an average brightness in the two periods is set to become a target brightness. Accordingly, a reduction in the brightness can be prevented while obtaining the impulsive effect.

While this invention has been described in connection with what is presently considered to be practical exemplary embodiments, it is to be understood that the invention is not limited to the disclosed embodiments but, on the contrary, is intended to cover various modifications and equivalent arrangements included within the spirit and scope of the appended claims.

What is claimed is:

1. A display device comprising:
a plurality of pixels, each of the pixels having a light-emitting element and a driving transistor that outputs a driving current to the light-emitting element;
a scan driver that supplies a scan signal to the pixels;
a signal controller that generates a first output image signal representing a brightness higher than a reference brightness and a second output image signal representing a brightness lower than the reference brightness, wherein an input image signal represents the reference brightness; and
a data driver that converts the first output image signal and the second output image signal into a first data voltage and a second data voltage, respectively, and alternately supplies the first data voltage and the second data voltage to the pixels,
wherein the first output image signal and the second output image signal are different from each other with respect to the input image signal.

2. The display device of claim 1, wherein the first and second output image signals are functions of the input image signal.

3. The display device of claim 2, wherein the first and second output image signals are linear functions of the input image signal.

4. The display device of claim 3, wherein y1=x and y2=ax (0<a<1), where y1 denotes the first output image signal divided by a total grayscale number, y2 denotes the second output image signal divided by the total grayscale number, and x denotes the input image signal divided by the total grayscale number.

5. The display device of claim 4, wherein a grayscale number of the second output image signal is smaller than that of the first output image signal.

6. The display device of claim 4, wherein the first data voltage is higher than a data voltage of the reference brightness.

7. The display device of claim 4, wherein the first data voltage is lower than a data voltage of the reference brightness.

8. The display device of claim 2, wherein the first and second output image signals are power functions of the input image signal.

9. The display device of claim 8, wherein a difference between the first output image signal and the second output image signal is greatest at an intermediate grayscale range

10. The display device of claim 9, wherein y1=xb (0.4<b<1) and y2=x^{c} (1.0<c<2.5), where y1 denotes the first output image signal divided by a total grayscale number, y2 denotes the second output image signal divided by the total grayscale number, and x denotes the input image signal divided by the total grayscale number.

11. The display device of claim 9, wherein y1=xd (0.4<d<1) and y2=fxe (1.0<e<2.5, 0.7<f<1), where y1 denotes the first output image signal divided by a total grayscale number, y2 denotes the second output image signal divided by the total grayscale number, and x denotes the input image signal divided by the total grayscale number.

12. The display device of claim 1, wherein a conversion equation for converting the input image signal into the first and second output image signals is different depending on a color representing the input image signal.

13. The display device of claim 1, wherein an average of the brightness represented by the first output image signal and the brightness represented by the second output image signal corresponds to the reference brightness represented by the input image signal.

14. The display device of claim 1, wherein the signal controller comprises:
a first data converter that converts the input image signal into the first output image signal according to a first lookup table;
a second data converter that converts the input image signal into the second output image signal according to a second lookup table; and
a selection unit that selects one of the first output image signal and the second output image signal and outputs the selected signal to the data driver.

15. The display device of claim 1, further comprising a voltage generator that applies a gray voltage to the data driver,
wherein the data driver selects the first and second data voltages based on the gray voltage.

16. A driving method of a display device including a plurality of pixels having a light-emitting element and a driving transistor that outputs a driving current to the light-emitting element, the method comprising:
converting an input image signal representing a reference brightness into a first output image signal representing a first brightness higher than the reference brightness;
converting the first output image signal into a first data voltage;
supplying the first data voltage to the pixels;
converting the input image signal into a second output image signal representing a second brightness lower than the reference brightness;
converting the second output image signal into a second data voltage; and
supplying the pixels with the second data voltage.

17. The driving method of claim 14, wherein the first and second output image signals are functions of the input image signal.

18. The driving method of claim 15, wherein y1=x and y2=ax (0<a<1), where y1 denotes the first output image signal divided by a total grayscale number, y2 denotes the second output image signal divided by the total grayscale number, and x denotes the input image signal divided by the total grayscale number.

19. The driving method of claim 15, wherein y1=x^{b} (0.4<b<1) and y2=x^{c} (1.0<c<2.5), where y1 denotes the first output image signal divided by a total grayscale number, y2 denotes the second output image signal divided by the total grayscale number, and x denotes the input image signal divided by the total grayscale number.

20. The driving method of claim 15, wherein y1=x^{d} (0.4<d<1) and y2=fx^{e} (1.0<e<2.5, 0.7<f<1), where y1 denotes the first output image signal divided by a total grayscale number, y2 denotes the second output image signal divided by the total grayscale number, and x denotes the input image signal divided by the total grayscale number.

21. The driving method of claim 14, wherein a conversion equation for converting the input image signal into the first and second output image signals is different depending on a color representing the input image signal.

22. The driving method of claim 14, wherein an average of the brightness represented by the first output image signal and the brightness represented by the second output image signal corresponds to the reference brightness represented by the input image signal.
